(19) United States
(12) Patent Application Publication
(10) Pub. No.: US 2007/0285915 A1
(43) Pub. Date: Dec. 13, 2007

(54) FITTING AND METHOD OF INSTALLATION

(76) Inventors: Paul Rosenau, Santa Ana, CA (US); Loren R. Perry, Fountain Valley, CA (US)

Correspondence Address: LAW OFFICES OF LARRY K. ROBERTS, INC., 2 Park Plaza, Suite 300, Irvine, CA, 92614, US

(21) Appl. No.: 11/423,378

(22) Filed: Jun. 9, 2006

(51) Int. Cl. F21V 33/00

(52) U.S. Cl. 362/101; 362/96

(57) ABSTRACT

A fitting adapted for installation into an opening of a support structure includes a housing structure having a longitudinal extent with a head region. An exemplary embodiment of the housing structure has an interference feature whose outer shape configuration generally matches a shape configuration of the opening, the interference feature oversized relative to the opening. The housing structure further includes a seal surface disposed generally transverse to the longitudinal extent. A component such as a light source may be disposed within the housing structure.

A method for installing a light fixture in an opening formed in a support structure includes positioning an end of the light fixture in the opening, applying an installation force on the light fixture to advance the light fixture into the opening such that an oversized interference feature on the exterior periphery of the light fixture tightly engages interior surfaces defining the opening in the support structure, and pushing the light fixture into the opening to engage a seal surface of the light fixture in engagement with a support structure surface around the opening.

### BACKGROUND

Many spa and other bathing installations include an illumination source for illuminating the body of water in the spa tub or bathing installation container, or adjacent areas or features. Exemplary light sources include LED, incandescent and fiber optic light systems.

Installation of the light source in the spa tub or bathing installation enclosure or other support structure is typically a time-consuming task.

### BRIEF DESCRIPTION OF THE DRAWINGS

FIG. 1 is an isometric partially exploded view of an exemplary embodiment of a light assembly for a spa installation.

FIG. 2 is a top view of the light assembly of FIG. 1.

FIG. 3 is a cross-sectional view of the light assembly of FIGS. 1-2, taken along line 3-3 of FIG. 2.

FIG. 4 is a cross-sectional view taken along line 4-4 of FIG. 3.

FIG. 5 is an enlarged view of the area within phantom line 5 of FIG. 3.

FIG. 6 is a cross-sectional view of an alternate embodiment of a housing for a light assembly.

FIG. 7 is a top view of the embodiment of FIG. 6.

FIG. 8 is a cross-sectional view of another alternative embodiment of a light assembly.

FIG. 9 is a top view of the embodiment of FIG. 8.

FIGS. 10 and 11 depict a spa waterfall structure employing light assemblies as depicted in FIGS. 8-9.

### DETAILED DESCRIPTION

In the following detailed description and in the several figures of the drawing, like elements are identified with like reference numerals. The figures may not be to scale, and relative feature sizes may be exaggerated for illustrative purposes.

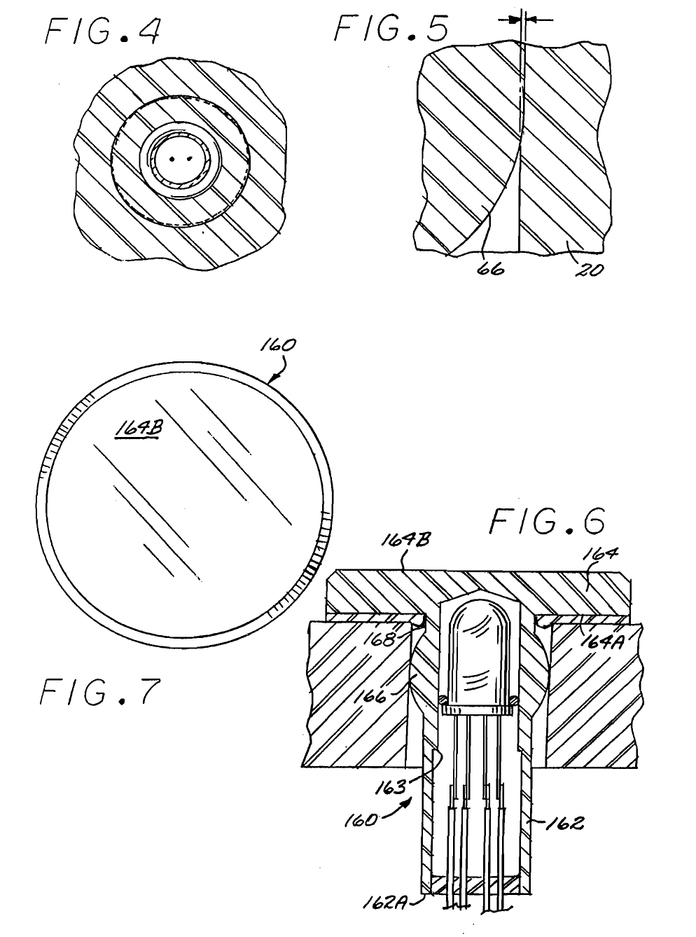

FIGS. 1-5 illustrate an exemplary embodiment of a light assembly 50. The assembly 50 may include a housing 60, a gasket 70, and an electrically powered light source 80. In an exemplary embodiment, the light source includes a light emitting diode (LED) or LEDs, although other types of light sources may be used, e.g. incandescent bulbs, or even an optical fiber transmitting light from a light source, e.g. a remotely located light source.

In an exemplary embodiment, the housing 60 is fabricated of a transparent or translucent material, e.g. polycarbonate or clear ABS. The housing includes a hollow tube or barrel portion 62, a head portion 64, and an interference feature 66 which protrudes from the outer periphery of the hollow tube portion 62 spaced from the head by a gap 68. In an exemplary embodiment, the housing 60 is designed to be interference fitted into a bore or opening 22 formed in a support structure 20, e.g., a spa tub wall. For example, the opening may be formed by drilling a hole in the support structure, and may have a circular cross-section. The housing barrel portion 62 and interference feature 66 may have a corresponding circular cross-sectional configuration for this example, with the outer diameter of the housing barrel portion 62 somewhat smaller than the nominal inner diameter of the opening 22. In an exemplary embodiment, the interference feature 66 may have a generally partial spherical contour, with an outer diameter at its outermost extremity which is somewhat larger than the opening diameter. The outer dimension of the interference feature 66 and the opening dimension are selected so that the housing may be interference fitted into the opening in a tight interference fit.

In other embodiments, the housing barrel portion 62 and interference feature 66 may have other cross-sectional configurations, e.g. matching non-circular opening configurations. For example, the opening may have a rectilinear configuration, and the housing barrel portion 62 and interference feature 66 may have a matching rectilinear configuration.

In an exemplary embodiment, the head portion 64 provides a flat seal surface 64A, against which the gasket 70 is positioned. The gasket in an exemplary embodiment may be fabricated of silicone, EPDM, VITON™, or liquid RTV silicone, preferably of a clear or translucent material. An exemplary gasket thickness range is between 0.030 inch to 0.10 inch, or more preferably 0.030 inch to 0.060 inch.

The light source assembly 80 may include, in an exemplary embodiment, a light source 82, which may be an LED source, positioned within the open space 80 within housing barrel portion 62 adjacent the head portion 64. An o-ring seal may be used to stabilize the position of the light source within the housing. The assembly 80 may also include a circuit board 84, to which are attached leads 86 which are connected to the light source 82 and leads 88A-88B which may connect to a source of electrical power, or in a daisy chain connection with other light source assemblies. A potting compound may be used to fix the position of the circuit board and seal the electrical components within the housing barrel portion 62.

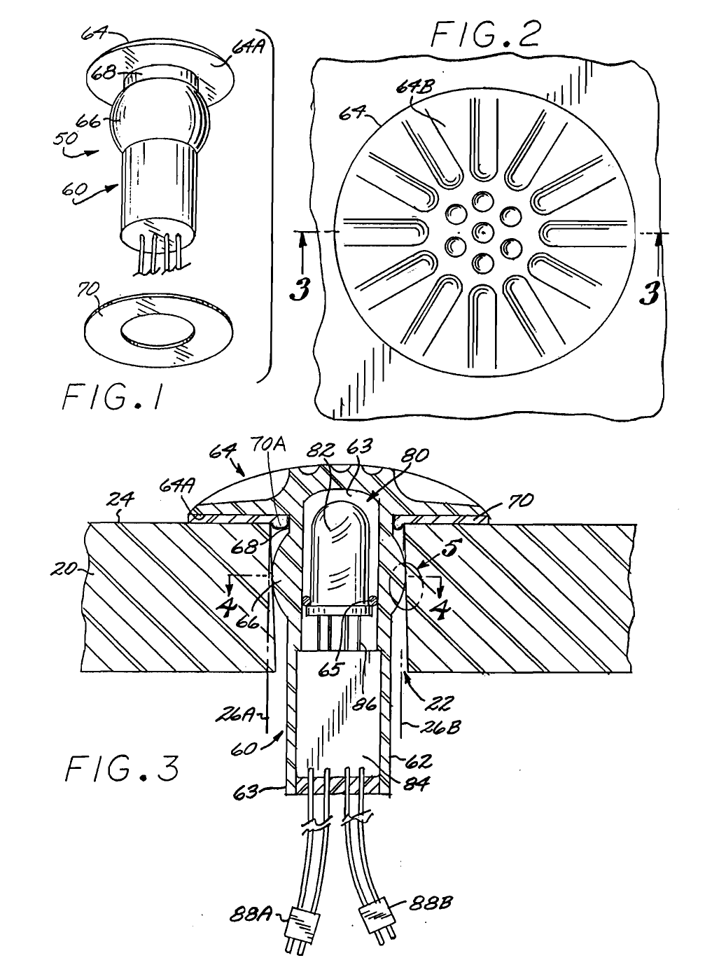

The exposed top surface 64B (FIG. 2) of the head portion 64 may include a lens pattern, or may be smooth or relatively featureless.

The light assembly 50 may be readily installed in a support structure such as a wall of a spa tub. An exemplary installation technique may include the steps of (a) forming an opening in the wall, e.g. by drilling a hole, (b) passing the leads 88A-88B through the opening, (c) inserting the housing end 63 into the opening, and (d) pushing assembly 50 into the opening until the head portion and gasket seat against the wall surface 24. In an exemplary embodiment, the interference feature 66 may be oversized with respect to the opening size such that an impact force may be applied to facilitate the seating of the assembly. For example, the impact force may be applied by a rubber mallet against the outer surface of the head portion 64. This seating may also compress the gasket 70 between the seal surface 64A and the surface 24 of the wall, to provide a liquid seal. The gasket portion 70A (FIG. 3) in the region between the neck region of the housing between the head 64 and the interference portion 66 may be relatively uncompressed, due to the opening gap between the support structure and the housing neck region. This uncompressed portion 70A may serve to capture the gasket position, keeping the gasket from squeezing out of position or sliding after installation. The interference fit of the feature 66 into the inner surface of the opening 22 may also provide some liquid sealing effect. In an embodiment in which the gasket 70 is formed by a liquid material such as RTV silicone, the gasket material may be dispensed into the opening 22 or onto the outer periphery of the housing 60, or both, prior to inserting the housing 60 into the opening 22.

For some embodiments, e.g., applications in which the LED assembly 50 is above a water line or in which it is unnecessary to provide a water-tight seal, the gasket 70 may be omitted, and the LED assembly installed without a gasket.

FIG. 5 illustrates the interference fit of the portion 66 and the wall surface of the opening 22. In the case of a spa tub, the wall may be fabricated of a fiberglass and resin structure, and there may be some compression of the wall to allow the interference portion to enter the opening 22. Alternatively, the interference portion may also or alternatively compress to allow entry into the opening.

It may be the case that the opening 22 is formed in the wall 20 at some offset from the perpendicular, or that the wall surface 22 is not completely true or flat. In the past, these types of features or imperfections may lead to difficulties in getting a light fitting head to lie flat against the wall surface. The interference feature 66 may ameliorate these difficulties, by provide some relatively limited range of rotational movement of the head portion within the opening about the interference feature. This is depicted in FIG. 3, wherein the dashed lines 26A-26B depict the orientation of an opening formed truly perpendicular to the wall surface 24, and so the actual opening is formed at a small angle offset from the perpendicular. Since in this embodiment the entire outer surface of the barrel portion of the housing is not in intimate contact with the opening wall due to its undersized diameter, the seal surface 64A may still be seated truly about the perimeter of the opening.

The housing 60 in an exemplary embodiment may be fabricated by injection molding, or by machining, or by other techniques.

FIGS. 6-7 illustrate an alternate embodiment of a housing structure 160 for a light assembly. In this exemplary embodiment, which may be machined from a cylindrical rod of transparent material such as polycarbonate or a clear ABS, the exposed head surface 164B of the head portion 164 is flat. In another embodiment, the housing structure may be molded. The following are exemplary dimensions for this embodiment, although it is to be understood that the particular dimensions are given for the sake of illustration of one embodiment, and that other dimensions may be appropriate for other applications and embodiments. The outer diameter of the head portion 164 is 0.75 inch. The barrel portion 162 has an outer diameter of 0.4 inch, and an inner diameter of 0.344 inch, which is stepped at shoulder 163 to a diameter of 0.295 inch. The interference feature 166 has an outer diameter at its largest dimension of 0.515 inch. A gap dimension 168 between the interference feature and the head seal surface 164A is 0.062 inch, providing space for a gasket (not shown in FIG. 6). The length of the tube portion 162 between end 162A and shoulder 163 is 0.55 inch, and the overall length of housing 160 in this embodiment is 1.055 inch. In an exemplary embodiment, the housing structure with these exemplary dimensions is adapted for installation in a nominal wall opening of ½ inch, with a nominal wall thickness of 3/16 inch or more.

The shoulder 163 of the housing structure 160 may provide a stop surface against which may be seated a circuit board assembly or other structure for a light source, for example.

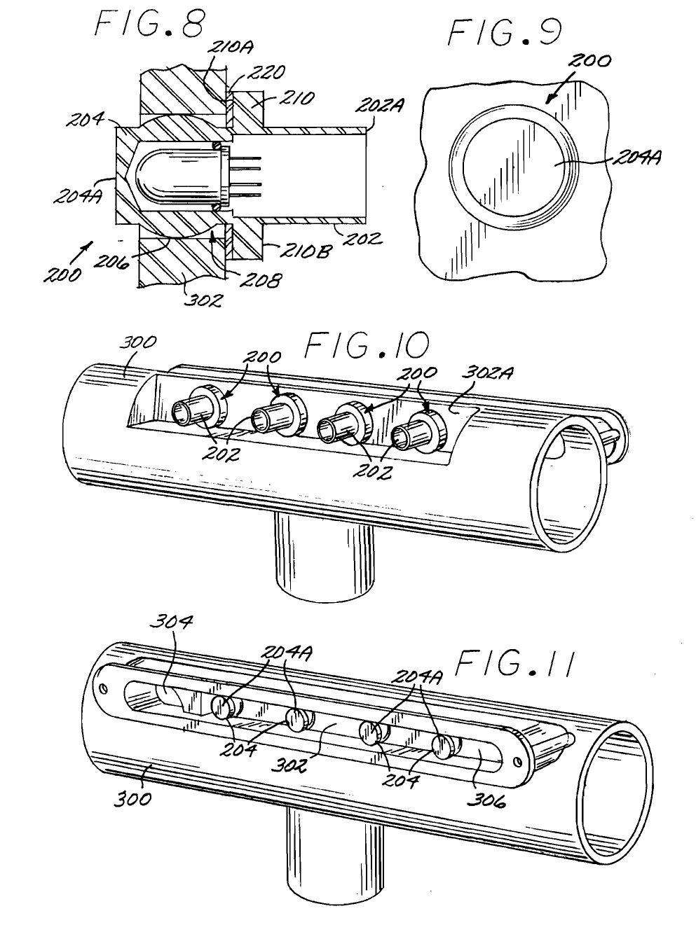

FIGS. 8-11 illustrate another alternate embodiment of a housing structure 200 for a light source. The housing structure 200 is designed to be installed from the opposite direction from that of housing structures 60 and 160. Thus, while housing structures 60 and 160 may be installed in a wall opening by inserting the end 63 or 162A of the tube portion 60 or 160 into the wall opening, housing structure 200 may be installed in an opening 304 in a support structure 302 by first inserting the head portion 204 into the opening.

As with the housing structures 60 and 160, the structure 200 includes a hollow tube portion 202, a head portion 204 and an interference feature 206. In this embodiment, the housing structure 200 further includes a flange portion 210 spaced from the interference feature 206 by a gap 208. A flange surface 210A provides a seal surface against which a gasket 220 will be seated when the housing structure is installed in a support structure. As with the housing structures 60 and 160, a light source assembly 230 may be installed within the hollow space inside the housing structure, with connection leads extending from the end 202A of the hollow portion 202.

An assembly including the housing structure 200 may be installed into an opening in a support structure. The opening is undersized relative to the outer dimension of the interference feature 206. An exemplary installation procedure includes inserting the head portion 204 into the opening, and applying an insertion force against the housing structure, e.g. on flange surface 210B, to force the interference feature into the opening, until the gasket and seal surface 210A are seated against the surface of the support structure surrounding the opening. For example, the insertion force may be applied by a rubber mallet, striking either end 202A or against an end of a pipe inserted over the tube portion with its distal end seated against the flange surface 210B.

One exemplary application for use of a light assembly including the housing structure 200 is illustrated in FIGS. 10-11. A waterfall structure 300 may be mounted adjacent a spa tub, and connected to a water supply, which results in a waterfall action from an outlet 304 and slot 306. The structure 300 includes a wall 302, into which openings are formed to receive the light assembly housing structures 200. The embodiment of FIGS. 10-11 depicts four housing structures, although more or less light assemblies may be employed as desired for a given application. To install the housing assemblies 200, the head of each may be inserted into the opening surface 302A (FIG. 10), and an insertion force applied to overcome the interference due to the interference feature 206, until the gasket 220 and seal surface 210A are engaged against the surface 302A.

Although the foregoing has been a description and illustration of specific embodiments of the invention, various modifications and changes thereto can be made by persons skilled in the art without departing from the scope and spirit of the invention as defined by the following claims.

What is claimed is:

1. A fitting adapted for installation into an opening of a support structure, the fitting comprising:
a hollow housing structure having a longitudinal extent with a head region;
the housing structure having an interference feature whose outer shape configuration generally matching a shape configuration of the opening of the support structure, the interference feature oversized relative to the opening;
the housing structure further including a seal surface disposed generally transverse to said longitudinal extent; and
a component disposed within said housing structure.

2. The fitting of claim 1, wherein the housing structure has an open end and a closed end, said head region disposed at or adjacent said closed end.

3. The fitting of claim 1, wherein said head region is an optically transparent region.

4. The fitting of claim 3, wherein said component comprises a light source.

5. The fitting of claim 4, wherein said light source comprises a light emitting diode (LED).

6. The fitting of claim 1, wherein said component includes a circuit board, and a plurality of leads passed from the circuit board through said open end.

7. The fitting of claim 1, wherein said seal surface faces said head region.

8. The fitting of claim 1, wherein said seal surface faces away from said head region.

9. The fitting of claim 8, wherein said support structure is a spa tub wall.

10. The fitting of claim 1, wherein said housing structure is fabricated of an optically translucent or transparent material.

11. The fitting of claim 1, wherein the interference feature comprises a generally spherical surface portion.

12. The fitting of claim 1, further comprising:
a gasket arranged to form a sealing contact with said seal surface and a surface of the support structure when the fitting is installed in the opening of the support structure.

13. The fitting of claim 12, wherein the gasket is an elastomeric member.

14. The fitting of claim 13, wherein the elastomeric member has a thickness range of 0.030 inch to 0.10 inch.

15. The fitting of claim 12, wherein the gasket is fabricated of an optically transparent or translucent material.

16. An electrically powered light assembly for a spa installation, adapted for installation into an opening of a spa support structure, the light assembly comprising:
a hollow housing structure having a longitudinal extent with an optically transparent head region;
the housing structure having an interference feature whose outer shape configuration generally matching a shape configuration of the opening of the spa support structure, the interference feature oversized relative to the opening;
the housing structure further including a seal surface disposed generally transverse to said longitudinal extent; and
a light source mounted in said housing structure for emitting light to pass through said head region.

17. The light assembly of claim 16, wherein the housing structure has an open end and a closed end, said head region disposed at or adjacent said closed end.

18. The light assembly of claim 16, wherein said light source comprises a light emitting diode (LED).

19. The light assembly of claim 16, wherein said component includes a circuit board, and a plurality of leads passed from the circuit board through said open end.

20. The light assembly of claim 16, wherein said seal surface faces said head region.

21. The light assembly of claim 16, wherein said seal surface faces away from said head region.

22. The light assembly of claim 21, and said spa support structure is a spa tub wall.

23. The light assembly of claim 22, wherein said opening is positioned below a water line of the spa tub.

24. The light assembly of claim 16, wherein said housing structure is fabricated of an optically translucent or transparent material.

25. The light assembly of claim 16, further comprising:
a gasket arranged to form a sealing contact with said seal surface and a surface of the support structure when the light assembly is installed in the opening of the support structure.

26. The light assembly of claim 25, wherein the gasket is an elastomeric member.

27. The light assembly of claim 26, wherein the elastomeric member has a thickness range of 0.030 inch to 0.10 inch.

28. The light assembly of claim 25, wherein the gasket is fabricated of an optically transparent or translucent material.

29. A method for installing a light fixture in an opening formed in a support structure, comprising:
positioning an end of the light fixture in said opening;
applying an installation force on the light fixture to advance the light fixture into the opening such that an oversized interference feature on the exterior periphery of the light fixture tightly engages interior surfaces defining the opening in the support structure;
pushing the light fixture into the opening to engage a seal surface of the light fixture in engagement with a support structure surface around the opening, said seal surface transverse to a direction of advancement of the light fixture into the opening.

30. The method of claim 29, wherein said pushing the light fixture into the opening further includes:
compressing at least a portion of a seal gasket member between said seal surface and said support structure surface.

31. The method of claim 30, wherein a portion of said seal gasket member adjacent said interference feature remains in an uncompressed condition relative to a compressed portion of said seal gasket member.

32. The method of claim 29, wherein said seal surface faces said end of the light fixture.

33. The method of claim 29, wherein said seal surface faces away from said end of the light fixture.

34. The method of claim 33, wherein said support structure is a spa tub wall.

35. The method of claim 29, wherein said light fixture includes a housing structure fabricated of an optically translucent or transparent material.

36. The method of claim 29, wherein said applying said installation force includes striking the fixture with a tool.
